(19) United States
(12) Patent Application Publication
(10) Pub. No.: US 2014/0026340 A1
(43) Pub. Date: Jan. 30, 2014

(54) SURFACE CLEANING ARTICLE AND PROCESS FOR MAKING THE SAME

(71) Applicant: HTI USA, INC., Southfield, MI (US)

(72) Inventors: Robert E. Buxbaum, Oak Park, MI (US); Herschel S. Wright, Southfield, MI (US)

(73) Assignee: HTI USA, INC., Southfield, MI (US)

(21) Appl. No.: 13/950,100

(22) Filed: Jul. 24, 2013

Related U.S. Application Data
(60) Provisional application No. 61/674,948, filed on Jul. 24, 2012.

(51) Int. Cl. C09G 1/16; B60S 3/04

(52) U.S. Cl. CPC C09G 1/16; B60S 3/045
USPC 15/104.93; 526/348.6; 510/395; 510/400; 526/338; 526/281

(57) ABSTRACT

An inventive composition that has utility as an article for cleaning a target surface is provided. Embodiments of the inventive composition are readily applied to a substrate to form a cleaning article or form a free-standing article; the composition upon drying forms a matrix having a coefficient of friction of greater than one, and a glass transition temperature that is between 0° C. and 40° C. The matrix is amenable to loading with various additives illustratively including re-enforcing fibers, abrasives, plasticizers, foaming agents, fragrances, and combinations thereof. Embodiments of the inventive composition operate to clean a substrate such as a vehicle and ideally return the same to the original look and feel without requiring excessive work, or requiring the removal of too much material from the surface.

### CROSS-REFERENCE TO RELATED APPLICATION

This application claims priority of U.S. Provisional Patent Application Ser. No. 61/674,948 filed Jul. 24, 2012, which is incorporated herein by reference.

### FIELD OF THE INVENTION

The present invention in general relates to surface cleaning and in particular to a cleaning article that uses intimate contact between the cleaning article and debris to promote debris removal from a target surface.

### BACKGROUND OF THE INVENTION

Historically, debris is cleaned from a surface through the application of mechanical abrasive force, chemical displacement, or combination thereof. While rubbing a target surface with conventional cleaning article often is adequate to remove debris electrostatically adhered to a target substrate, many types of debris are resinous or oily thereby making removal by simply imparting mechanical forces to the debris difficult. In such instances, it is routine to include an abrasive that serves to focus mechanical energy input to the debris particulate, while surfactants serve to solubilize debris. Unfortunately, resort to abrasives and surfactants, each create difficulties. Specifically, abrasives tend to mar the target surface and over time visibly damage the target surface, while surfactants are slow to lift debris and tend to leave film on the target surface that promotes redeposition of debris.

Most American automobiles are factory painted with several layers of colored and clear paint or paint-like coatings that together produce a beautiful luster and a smooth feel to the touch, the luster and smooth feel serving to enhance the value of the car in the eyes of the owner. Over time, the painted/coated surface becomes damaged though by the forces of nature: UV radiation from the sun damages the upper surface of the coat causing it to feel rough; air causes the paint to oxidize and lose shine; wind-borne dust produces nicks and scratches in the surface; and dust and grease can become embedded in the surface, as well as, paint overspray and industrial fallout such as rail dust. These agents act together to dull the look and roughen the feel.

Many polishing products already appear on the market. These fall into 3 general categories: Liquid or semi-solid Polishing paste (e.g. Turtle wax), Clay polishing erasers (e.g. The magic eraser), and a polishing towel and pad as described by Taiwan Patent 1247801 and U.S. Pat. No. 7,867,967. The liquid compounds are messy to use and have a time consuming application. The clay eraser is less time consuming and less messy. The present invention is roughly as easy to use as the towel patent but is a lot cheaper and easier to manufacture, as it does not require any nano-fibers in the composition. Instead, in our patent, we get the same effect as with nano-fibers, but with the use of ordinary abrasive filler and an appropriate polymer matrix. Polymers that satisfy the above condition include PBS copolymer when plasticized to produce the appropriate glass transition and friction behaviors. Other rubber options include natural rubber, latex, when appropriately plasticized, polynorborene rubbers and mixtures of the appropriate glass transition, and polyvinylchloride plasticized to produce the appropriate glass transition and friction behavior.

The cleaning of a vehicle exterior surface inclusive of windows, trim, and painted surfaces are exemplary of target surfaces of high value that are exposed to considerable buildup of grime and debris. A vehicle surface is also highly prone to diminished visual appearance through repeated conventional cleaning. In order to address the above-noted limitations associated with target surface cleaning with a sponge or cloth, alone or with abrasives, surfactants, or combination thereof, others have resorted to the use of a clay-like bar that when pressed into intimate contact with a target surface tends to lift debris by weakening van der Waal and hydrogen bonding between the debris and the target surface to affect debris lift from the target surface with less transverse force being imparted to the target surface than with a conventional rubbing action. While such clay-like articles create less damage to the target surface over time, the clay-like bar tends to transfer clay-like residue to the surface which then requires secondary effort to remove. Further, through repeated use of the bar and the kneading of the debris into the bar also has a tendency to redeposit debris onto the surface. As a result clay-like bars after usage often require additional labor associated with surfactant cleaning to remove the byproducts of clay-like bar cleaning. Additionally, the clay-like material can easily become contaminated with debris if dropped on the floor rendering it unusable.

In order to address the limitations of clay-like surfaces, resinous coatings have been developed based upon a colloidal material an abrasive present in a resin matrix along with natural fibers. Taiwan Patent Publication 1247801 and U.S. Pat. No. 7,867,967 are exemplary of such substances that are applied as a coating on a sponge or other cleaning article. Unfortunately, such articles tend to be thermally unstable and still require a considerable force to be imparted to the target surface with included abrasive powders still having the ability to mar a target surface.

Thus, there is an existing need for a surface cleaning article that is able to remove debris form a target surface reliably and with limited transverse motion of the cleaning article across the target surface. There also exists a need for a composition that may be applied to a variety of conventional cleaning articles to facilitate target surface cleaning, with limited resort to transverse mechanical forces and substances that can potentially damage a target surface.

### SUMMARY OF THE INVENTION

The present inventive composition has utility as an article for cleaning a target surface. Embodiments of the inventive composition are readily applied to a substrate to form a cleaning article or form a free-standing article; the composition upon drying forms a matrix having a coefficient of friction of greater than one, and a glass transition temperature that is between 0° C. and 40° C. The matrix is amenable to loading with various additives illustratively including re-enforcing fibers, abrasives, plasticizers, foaming agents, fragrances, and combinations thereof.

Embodiments of the inventive composition operate to clean a substrate such as a vehicle and ideally return the same to the original look and feel without requiring excessive work, or requiring the removal of too much material from the surface.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a cross-sectional view of an inventive surface cleaning article having a surface coating of an inventive composition; and

FIG. 2 is a cross-sectional view of an inventive surface cleaning free standing article of an inventive composition.

### DESCRIPTION OF THE INVENTION

The present invention has utility as an article for cleaning a target surface. A composition is provided that is readily applied to a substrate to form a cleaning article or form a free-standing article; the composition upon drying forms a matrix having a coefficient of friction of greater than one, and a glass transition temperature that is between 0° C. and 40° C. The matrix is amenable to loading with various additives illustratively including re-enforcing fibers, abrasives, plasticizers, foaming agents, fragrances, and combinations thereof.

The present invention operates to clean a substrate such as a vehicle and ideally return the same to the original look and feel without requiring excessive work, or requiring the removal of too much material from the surface. Without intending to be bound to a particular theory, an inventive matrix acts like nanometer size suction cups that pull up surface debris, and to remove any micro-scale flakes of damaged paint. In a specific embodiment, this polymeric matrix is combined with an abrasive to remove larger bits of embedded dust. In another specific embodiment, matrix material is coated onto a sponge, cloth, or similar material to make it easier to hold and use.

Without intending to be bound to a particular theory, a molten polymer has some attractive operating properties for removing damage from a surface, such as a vehicle except for the fact that some of the gum polymer would tend to stick to the surface and dulling the shine. Instead of chewing gum like material, according to the present invention, a solid thermoset or thermoplastic rubbery polymer is provided where the polymer is chosen to have a coefficient of friction of greater than one, and a glass transition temperature that is close to room temperature and between 0° C. and 40° C. That is the force of friction between a piece of the rubber and a surface to be cleaned should be greater than the normal force pushing down, and the glass transition temperature is between 0° C. and 40° C. and in some embodiments between 10° C. and 30° C. The glass transition temperature of a polymer is related to nano-scale molecular motion, and coatings or free-standing thermoplastic polymers with this range of glass transition tend to have the right detritus-gripping abilities.

Use of a solid, rubbery polymer is necessary so that the polymer will not leave a film on the surface of the car surface creating its own dullness, but will insure that it can flex over the contoured surface allowing it be able to attach to the dust and detritus there. In a preferred manifestation, the polymer will be filled (compounded) with some very fine grit, (average size 10μ or less) and attached to a cloth, sponge, or foam block. Addition of the grit is not a necessary component of embodiments of the inventive cleaner, but the grit seems to produce a better polishing experience, especially with highly damaged car surfaces.

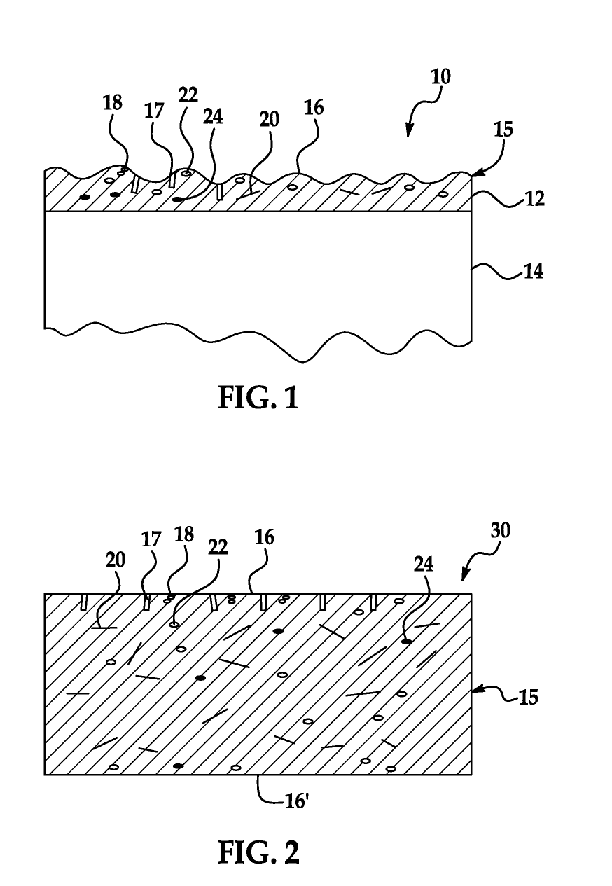

An inventive matrix in deforming upon contact with contours of a target surface has been found to clean debris from the target surface with a lessened need for transverse mechanical force application relative to the target surface, as well as simultaneous or subsequence reliance on surfactants. Referring now to the figures, an inventive article for cleaning a target surface is shown in cross-section generally at 10 in FIG. 1. The Article 10 includes a coating 12 adhered to a substrate 14. The coating 12 forms a matrix 15 having an exposed surface 16. The matrix 15 is formed of a thermoplastic elastomer that deforms and recovers slowly to original form upon relaxation resulting in a high degree of vibrational damping. An attribute of an inventive matrix is a coefficient of friction of greater than one, and a glass transition temperature that is close to room temperature and between 0° C. and 40° C. In contrast to many cross-linked thermoset elastomeric materials, the inventive matrix is formed form a thermoplastic material and as such is readily applied to a substrate without result to strenuous conditions associated with vulcanization. Rather, an inventive composition is also provided to form a coating or a free-standing article of a matrix 15 in which the thermoplastic elastomer is dissolved in a solvent along with additives as desired, the additives being specific to individual embodiments of the present invention. With evaporation of the solvent, an inventive coating 12 on a substrate 14 results or a free-standing portion of such a matrix as detailed hereafter with respect to FIG. 2. A matrix 15 is formed from butyl rubber, acrylonitrile-butadiene rubber (NBR), polynorborene, or a combination thereof. It is also appreciated that thermoplastic elastomers that intrinsically do not possess a tan δ of between 0.3 and 3 are readily rendered to possess such a value through the inclusion of reinforcing fibers, fillers, resins, plasticizers, or combinations thereof. Such thermoplastic elastomers rendered suitable for the present invention through such modification include natural rubber, styrene-butadiene rubber (SBR), polybutadiene rubber, silicone rubbers, chloroprene rubber, and combinations thereof. A matrix 15 is typically applied to a substrate 14 with a thickness of between 0.1 and 10 mm. The substrate 14 includes a variety of conventional substrates for cleaning of a target surface. Substrate 14 illustratively includes in specific embodiments a natural sponge, a synthetic sponge, a fibrous material forming a cloth in a woven or non-woven form, natural chamois, a synthetic polymer having a grain similar to that of a natural chamois, and a rotary buffing pad. Specific embodiments of synthetic sponge materials include polyurethane foams with either open-cell foam or closed-cell foams. Such synthetic sponges are routinely formed as buffing pads. The coating 12 has an exposed face 16 that is either smooth or contoured. A contour to exposed face 16 is shown in FIG. 1 with typical peak to valley differences of between 0.3 and 3 millimeters between adjacent peaks and valleys in the exposed face 16. A contour is readily provided to exposed face 16 through pulsed air evaporation of solvent from a composition from which coating 12 is formed, flexure of substrate 14, or embossing a partially dry coating 12 with an embossing roller or platen. It is appreciated that it is readily processed to form perforations 17 through non-contact modification such as laser like or water spray boring; or with a mechanical stylus. In addition to perforations 17, it is appreciated that an inventive coating 12 is readily rendered to include vacuoles 18, the vacuoles 18 either being closed-celled or open-celled through result to inclusion of a foaming agent or flash solvent volatilization of solvent carrying the matrix thermoplastic elastomer.

The matrix 15 in specific embodiments also includes at least one of reinforcing fibers, abrasives, plasticizers, fragrances, foaming agents, and a combination thereof. A reinforcing fiber 20, if present, in certain embodiments is present in a range of between 0.1 and 20 total weight percent of the coating 12. Exemplary reinforcing fibers operative herein include glass, carbon, cotton, hemp, silk, and combinations thereof. Abrasives 22, if present, in specific embodiments of the present invention are included in amounts of between 0.1 and 40 total weight percent of the coating 12. It is appreciated that the amount and nature of the abrasive 22 are dictated by factors illustratively including size, faceting, Mohs hardness, and particle size of the abrasive 22, the degree of abrasiveness desired, hardness of the target surface, bonding strength between debris and the target surface, time allocated for target surface cleaning, and force with which a coating 12 is applied to a target surface. Typical sizes of abrasive 22 operative herein 0.01 and 100 microns. Exemplary abrasive 22 operative herein include calcium carbonate, nutshell powder, corncob grit, waxes, carbon black, colloidal silica, alumina, titania; colloidal forms thereof; and combinations thereof, metal oxides, and combinations thereof. A pigment 24, if present, is added in certain embodiments in an amount of from 0.1 to 2 total weight percent of the coating 12. It is appreciated that a pigment 24, itself, may have a degree of abrasiveness and is present to modify different grades of abrasiveness associated with an inventive article. Exemplary pigments include metal oxides such as iron oxide, manganese oxide, and titania; metal complexes such as those of copper; and combinations thereof. A plasticizer, if present, is found in specific embodiments in amounts of between 0.05 and 6 total weight percent of the coating 12. Exemplary plasticizers for thermoplastic elastomers forming the matrix 15 include triphenyl phosphate butyl benzyl phthalate, and combinations thereof. A foaming agent, if present, is found in specific embodiments in amounts of between 0.01 and 3 total weight percent, and are either thermally or chemically activated. Exemplary foaming agents operative in the present invention include baking powder, isocyanates, titanium hydride, isocyanates; and high volatility solvents such as pentane and halocarbons.

FIG. 2 depicts an article formed by drying an inventive composition to form a free-standing article that is synonymously referred to herein as free standing matrix is shown generally at 30. With respect to FIG. 2, like numerals have the meaning ascribed thereto with respect to FIG. 1. The article 30 is depicted with an opposing exposed face 16′ that is smooth. It is of note that the article 30 has two working surfaces designed to form to engage a target surface.

Without intending to be bound to a particular theory, it is believed that when an inventive exposed face 16 or 16′ contacts debris on a target surface, deformation of the thermoplastic elastomer matrix 15 around particulate debris and the slow relaxation of the matrix around the debris is sufficient to create an electrostatic attraction between the debris and the matrix sufficient to lift the same from the target surface and upon contacting the debris coated matrix exposed face 16 or 16′ to water, the debris lifts from the face to provide a clean exposed face 16 or 16′ for subsequent contact with a target surface. Target surfaces cleaned by an inventive article illustratively include interior vehicle surfaces, exterior vehicle surfaces, marine craft, windows, furniture, building siding, fences, metal, and wood.

In certain embodiments, inventive coating 12 or free standing matrix 30 are formed by dissolving or suspending a thermoplastic elastomer an appropriate solvent along with any additives present in mixing to form a homogeneous mixture. The mixture is suitable for pouring into a mold to form free standing matrix 30 or application to a substrate 14 to form a coating 12. With solvent evaporation the mixture increases in viscosity and is amenable to embossing, foaming, or other processing during or subsequent to solvent evaporation. A composition with specific embodiments contains between 50 and 98% by weight of solvent with the remainder of the composition being the aforementioned residual components of the coating 12 or free standing matrix 30. Solvents suitable for dissolving or disbursing the thermoplastic elastomer appreciated to depend on the nature of the elastomer generally include acetyl acetate, xylene, toluene, methyl ethyl ketone, and combinations thereof.

The foregoing description is illustrative of particular embodiments of the invention, but is not meant to be a limitation upon the practice thereof. The following claims, including all equivalents thereof, are intended to define the scope of the invention.

1. A surface polishing article comprising: a thermoplastic polymer with a glass transition temperature that is between 0° C. and 40° C.

2. The article of claim 1 further comprising an abrasive having an abrasive average particle size of less than 25 microns.

3. The article of claim 2, wherein the abrasive average particle size is less than 10 microns.

4. The article of claim 2 where said abrasive has an abrasive volume greater than a volume of said polymer.

5. (canceled)

6. (canceled)

7. The article of claim 1 further comprising a substrate to which said polymer is adhered.

8. The article of claim 7 where said substrate is chosen from one of: a towel, a sponge, or a foam pad.

9. (canceled)

10. An article for cleaning a target surface comprising: a substrate deformable to a contour of the surface, a coating on said substrate, said coating having an exposed face, said coating comprising: a matrix formed of a thermoplastic elastomer with coefficient of friction of greater than one, and a glass transition temperature that is between 0° C. and 40° C.

11. The article of claim 10 wherein said substrate is an open-celled or close-celled foam.

12. (canceled)

13. (canceled)

14. The article of claim 12 wherein said sponge is in the shape of a rotary buffing pad.

15. The article of claim 10 wherein said substrate is a fabric sheet.

16. (canceled)

17. (canceled)

18. The article of claim 10 wherein said substrate is a bristle.

19. (canceled)

20. The article of claim 10 wherein said coating has a thickness of between 0.1 and 10 mm.

21. (canceled)

22. (canceled)

23. (canceled)

24. The article of claims 10 further comprising perforations in the exposed face.

25. The article of claim 10 further comprising vacuoles in the exposed face.

26. (canceled)

27. The article of claim 10 further comprising at least one additive of reinforcing fiber, abrasive, plasticizer, foaming agent, a fragrance, and a combination thereof.

28-32. (canceled)

33. A combination for forming a coating for a clean article comprising:
a plastic polymer with a glass transition between 0 and 30 degrees C., where said polymer does not contain any significant quantity of nano-fiber; and
a solvent in which said thermoplastic elastomer is dissolved or dispersed.

34. The composition of claim 33 further comprising at least one additive of reinforcing fiber, abrasive, plasticizer, or a combination thereof.

35. The composition of claim 33 wherein said solvent is present from 10 to 95 total weight percent of the composition.

36. (canceled)

37. The composition of claim 36 wherein said formed article is in the shape of a block.

38. (canceled)
